(19) United States
(12) Patent Application Publication
(10) Pub. No.: US 2025/0308802 A1
(43) Pub. Date: Oct. 2, 2025

(54) LAMINATED CERAMIC CAPACITOR AND METHOD FOR MANUFACTURING LAMINATED CERAMIC CAPACITOR

(71) Applicant: TAIYO YUDEN CO., LTD., Tokyo (JP)

(72) Inventors: Yuta KOBAYASHI, Tokyo (JP); Yoshiaki SEKIGUCHI, Tokyo (JP); Michio OSHIMA, Tokyo (JP); Hiroki SHINODA, Niigata (JP); Koji MIURA, Niigata (JP)

(73) Assignee: TAIYO YUDEN CO., LTD., Tokyo (JP)

(21) Appl. No.: 19/084,667

(22) Filed: Mar. 19, 2025

(30) Foreign Application Priority Data
Mar. 28, 2024 (JP) 2024-054521

(51) Int. Cl. H01G 4/30; H01G 4/008; H01G 4/012; H01G 4/12

(52) U.S. Cl. CPC H01G 4/30; H01G 4/008; H01G 4/012; H01G 4/12

(57) ABSTRACT

A laminated ceramic capacitor includes a laminated body having a laminated structure of a plurality of dielectric layers containing a ceramic and a plurality of internal electrode layers that are alternately laminated. The laminated body has first and second side surfaces facing each other and first and second end surfaces facing each other. The internal electrode layers include first and second internal electrode layers. A length of the first internal electrode layer in a first direction in which the first and second side surfaces face each other is longer than a length of the second internal electrode layer in the first direction. The first internal electrode layer has at least one protrusion on a first surface facing the second internal electrode layer. The protrusion is in a region where the first and second internal electrode layers do not overlap in a lamination direction in the first internal electrode layer.

### CROSS-REFERENCE TO RELATED APPLICATION(S)

This application is based upon and claims the benefit of priority from Japanese Patent Application No. JP2024-054521, filed Mar. 28, 2024, the entire contents of which are incorporated herein by reference.

### BACKGROUND

### 1. Technical Field

The present disclosure relates to a laminated ceramic capacitor and a method for manufacturing a laminated ceramic capacitor.

### 2. Description of the Related Art

Laminated ceramic capacitors with a large size, a large capacitance, and high reliability are required for in-vehicle computers and the like. JP 2000-124057 A describes a laminated ceramic capacitor that changes areas of internal electrodes arranged to face each other via a ceramic sheet in each internal electrode, thereby dispersing the tensile stress generated in a margin portion when a voltage is applied to the internal electrodes and suppressing occurrence of cracks.

### SUMMARY

However, when the areas of the internal electrodes are made different as in the configuration of JP 2000-124057 A, sparseness and denseness of an amount of metal elements diffused from each internal electrode occur in the vicinity of an end of an internal electrode layer having a large area and in the vicinity of an end of an internal electrode layer having a small area, which are regions where the internal electrodes do not overlap each other in a lamination direction. Thus, a difference in composition may occur in a dielectric layer and become a starting point of delamination.

One aspect of the present disclosure is to provide a laminated ceramic capacitor having excellent adhesion between a dielectric layer and an internal electrode layer and capable of suppressing delamination.

In order to solve the above and other problems, one aspect of the present disclosure provides a laminated ceramic capacitor including a laminated body having a laminated structure in which a plurality of dielectric layers containing a ceramic as a main component and a plurality of internal electrode layers are alternately laminated. The laminated body has a first side surface and a second side surface facing each other and a first end surface and a second end surface facing each other. The internal electrode layers include a first internal electrode layer and a second internal electrode layer. A length of the first internal electrode layer in a first direction in which the first side surface and the second side surface face each other is longer than a length of the second internal electrode layer in the first direction. The first internal electrode layer has at least one protrusion on a first surface facing the second internal electrode layer. The protrusion is in a region where the first internal electrode layer and the second internal electrode layer do not overlap in a lamination direction in the first internal electrode layer.

Accordingly, a laminated ceramic capacitor having excellent adhesion between a dielectric layer and an internal electrode layer and capable of suppressing delamination may be provided.

### BRIEF DESCRIPTION OF THE DRAWINGS

FIG. 1 is a partial cross-sectional perspective view of an example of a laminated ceramic capacitor according to an aspect of the present disclosure;

FIG. 2 is a cross-sectional view of the laminated ceramic capacitor of FIG. 1 taken along line A-A;

FIG. 3 is a cross-sectional view of the laminated ceramic capacitor of FIG. 1 taken along line B-B;

FIG. 4A is a partial cross-sectional perspective view of a laminated ceramic capacitor having no protrusion, FIG. 4B is a cross-sectional view taken along line A-A of FIG. 4A, and FIG. 4C is a cross-sectional view taken along line B-B of FIG. 4A;

FIG. 5 is an enlarged schematic view of a region M1 in FIG. 4C;

FIG. 6 is an enlarged schematic view of a region M1 in FIG. 3;

FIG. 7 is a partial cross-sectional perspective view of an example of a laminated ceramic capacitor according to an aspect of the present disclosure;

FIG. 8 is a cross-sectional view of the laminated ceramic capacitor of FIG. 7 taken along line A-A;

FIG. 9 is a cross-sectional view of the laminated ceramic capacitor of FIG. 7 taken along line B-B;

FIG. 10 is a flowchart showing an example of a method for manufacturing a laminated ceramic capacitor according to an aspect of the present disclosure;

FIGS. 11A to 11E show an example of a lamination step of a method for manufacturing a laminated ceramic capacitor according to an aspect of the present disclosure;

FIGS. 12A and 12B show an example of a lamination step of a method for manufacturing a laminated ceramic capacitor according to an aspect of the present disclosure;

FIG. 13 shows an example of a lamination step of a method for manufacturing a laminated ceramic capacitor according to an aspect of the present disclosure;

FIGS. 14A to 14C are a schematic view of a first internal electrode layer in which a protrusion is formed in a laminated ceramic capacitor according to an aspect of the present disclosure and is a view showing results of surface shape analysis of the first internal electrode layer in a first direction; and

FIGS. 15A to 15C are a schematic view of a first internal electrode layer in which a protrusion is formed in a laminated ceramic capacitor according to an aspect of the present disclosure and is a view showing results of surface shape analysis of the first internal electrode layer in a first direction.

### DETAILED DESCRIPTION

Hereinafter, aspects of the present disclosure will be described in detail, but the present disclosure is not limited thereto. In the present specification and the drawings, components having substantially the same functional configuration will be denoted by the same reference signs, and redundant description will be omitted in some cases. In the present specification, “orthogonal” means “orthogonal” and “substantially orthogonal”. Hereinafter, a laminated ceramic capacitor will be described with reference to the drawings.

### (Laminated Ceramic Capacitor)

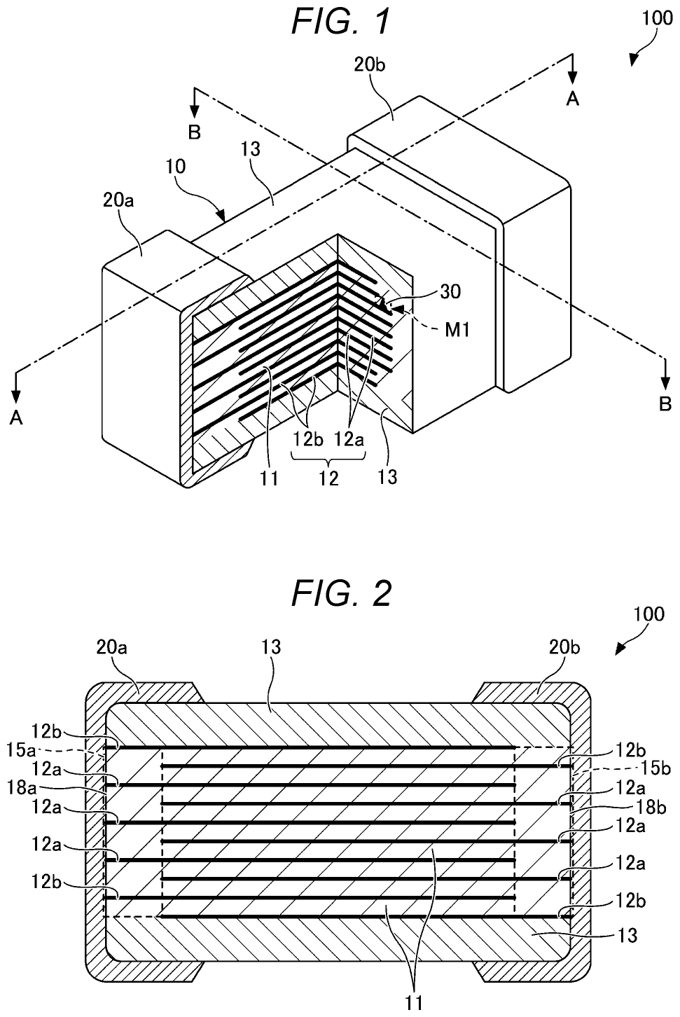

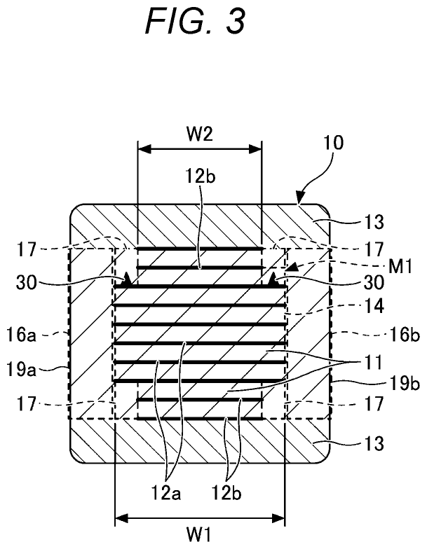

FIG. 1 is a partial cross-sectional perspective view of an example of a laminated ceramic capacitor according to an aspect of the present disclosure. FIG. 2 is a cross-sectional view taken along line A-A of FIG. 1. FIG. 3 is a cross-sectional view taken along line B-B of FIG. 1. As shown in FIGS. 1 to 3, a laminated ceramic capacitor 100 includes a laminated chip 10 having a substantially rectangular parallelepiped shape and external electrodes 20a and 20b provided on any two facing end surfaces of the laminated chip 10. One of the above two end surfaces of the laminated chip 10 will be referred to as a first end surface, and the other will be referred to as a second end surface. As long as the first end surface and the second end surface are one of the end surfaces of the laminated chip 10, either surface may be a first end surface 18a or a second end surface 18b. Among four surfaces other than the first end surface 18a or the second end surface 18b, two surfaces other than an upper surface or a lower surface in a lamination direction will be referred to as side surfaces, one will be referred to as a first side surface, and the other will be referred to as a second side surface. As long as the first side surface and the second side surface are side surfaces of the laminated chip 10, either surface may be a first side surface 19a or a second side surface 19b. Because a surface at the end in the lamination direction is defined as the upper surface or the lower surface, the upper surface of the laminated chip 10 is not specified as being provided on the upper side, and, as long as the surface is a surface at the end in the lamination direction, either surface may be the upper surface or the lower surface. The external electrodes 20a and 20b extend to the upper surface and the lower surface of the laminated chip 10 in the lamination direction, the first side surface 19a, and the second side surface 19b. Note that the external electrodes 20a and 20b are separate from each other.

The laminated chip 10 has a laminated structure in which dielectric layers 11 containing a ceramic material functioning as a dielectric and internal electrode layers 12 are alternately laminated. End edges of the internal electrode layers 12 are alternately exposed to the first end surface 18a of the laminated chip 10 on which the external electrode 20a is provided and the second end surface 18b thereof on which the external electrode 20b is provided. Thus, the internal electrode layers 12 are alternately conductive to the external electrode 20a and the external electrode 20b. The upper surface and the lower surface of the laminated chip 10 in the lamination direction of the dielectric layers 11 and the internal electrode layers 12 (hereinafter, referred to as the lamination direction) are formed by cover layers 13. The cover layers 13 contain a ceramic material as a main component. For example, the main component material of the cover layers 13 is the same as the main component material of the dielectric layers 11. In the present specification, the “main component” means a component contained in the largest amount among contained components in terms of the proportion of an amount of substance.

As shown in FIGS. 2 and 3, a region where the internal electrode layers 12 connected to the external electrode 20a and the internal electrode layers 12 connected to the external electrode 20b face each other is a region where a capacitance is generated in the laminated ceramic capacitor 100. Therefore, the region where a capacitance is generated will be referred to as a capacitance portion 14. That is, the capacitance portion 14 is a region where adjacent internal electrode layers 12 connected to different external electrodes face each other.

As shown in FIG. 2, regions where the internal electrode layers 12 connected to the external electrode 20a face each other without sandwiching the internal electrode layer 12 connected to the external electrode 20b and vice versa will be referred to as a first end margin portion 15a and a second end margin portion 15b, respectively. That is, the first end margin portion 15a and the second end margin portion 15b are regions where the internal electrode layers 12 connected to the same external electrode face each other without sandwiching the internal electrode layer 12 connected to a different external electrode. The first end margin portion 15a and the second end margin portion 15b are regions where no capacitance is generated.

As shown in FIG. 3, in the laminated chip 10, regions from the two side surfaces of the laminated chip 10 to a first internal electrode layers 12a will be referred to as a first side margin portion 16a and a second side margin portion 16b, respectively. That is, the side margin portions 16a and 16b are regions provided to cover ends of the plurality of first internal electrode layers 12a laminated in the laminated chip 10, the ends extending toward the two side surfaces. The first side margin portion 16a and the second side margin portion 16b are also regions where no capacitance is generated.

As shown in FIG. 3, a portion surrounded by the cover layer 13, the first side margin portion 16a or the second side margin portion 16b, and the capacitance portion 14 will be referred to as a margin portion 17. The margin portion 17 is also a region where no capacitance is generated.

As shown in FIG. 3, in the laminated ceramic capacitor 100, the width of the internal electrode layers 12 changes in two stages in a direction in which the first side margin portion 16a and the second side margin portion 16b face each other, that is, in a first direction in which the first side surface 19a and the second side surface 19b face each other (hereinafter, referred to as the first direction). More specifically, as shown in FIG. 3, the internal electrode layers 12 include the first internal electrode layers 12a and second internal electrode layers 12b, and a width W2 that is the length of the second internal electrode layers 12b in the first direction is smaller than a width W1 that is the length of the first internal electrode layers 12a in the first direction. That is, the length of the first internal electrode layers 12a in the first direction is longer than the length of the second internal electrode layers 12b in the first direction. The lamination direction and the first direction are orthogonal to each other. At least one first internal electrode layer 12a has at least one protrusion 30 on one surface facing the second internal electrode layer 12b in a region M1 where the first internal electrode layer 12a and the second internal electrode layer 12b do not overlap each other in the lamination direction in the first internal electrode layer 12a. Note that the margin portion 17 may be one of the regions M1. The at least one protrusion 30 extends in the lamination direction from the first internal electrode layer 12a towards the facing second internal electrode layer. Herein the at least one first internal electrode layer 12a is an outermost layer, e.g., an uppermost layer of the plurality of first internal electrode layers 12a. Because of the protrusion 30, adhesion between the dielectric layers and the internal electrode layers is improved, allowing delamination to be suppressed. This point will be specifically described.

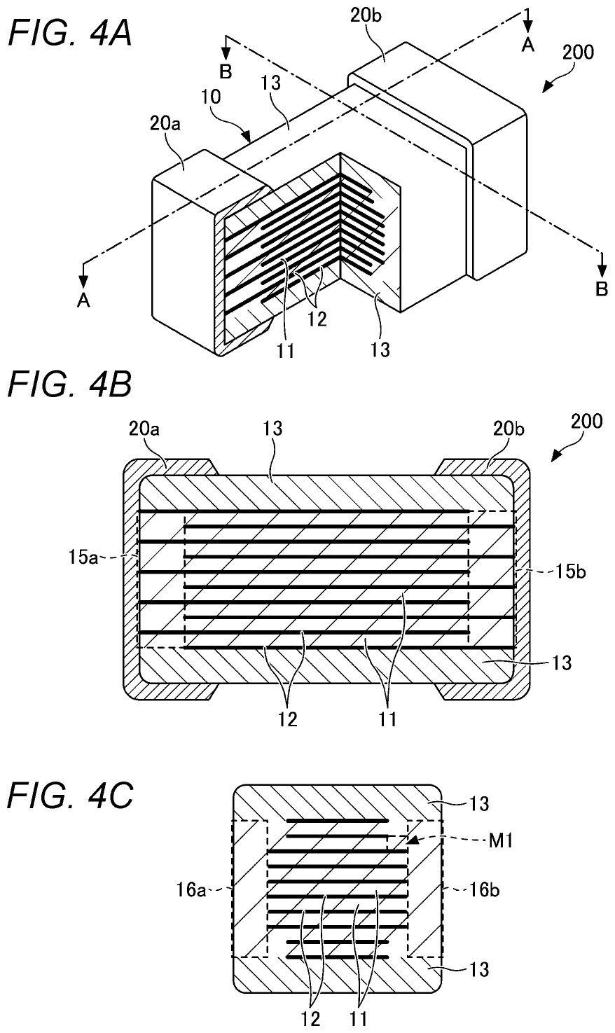

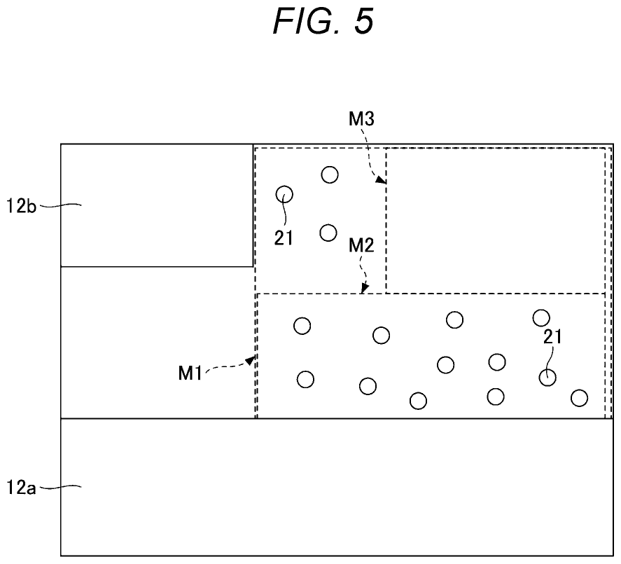

First, unlike the laminated ceramic capacitor 100 according to the present embodiment, a laminated ceramic capacitor 200 in which no protrusion is in the first internal electrode layer 12a will be described. FIG. 4A is a partial cross-sectional perspective view of the laminated ceramic capacitor 200 having no protrusion in the internal electrode layer 12a, FIG. 4B is a cross-sectional view taken along line A-A of FIG. 4A, and FIG. 4C is a cross-sectional view taken along line B-B of FIG. 4A. As shown in FIG. 4C, the laminated ceramic capacitor 200 has a similar configuration to the laminated ceramic capacitor 100 except for not having a protrusion. FIG. 5 is an enlarged schematic view of the region M1 in FIG. 4C.

As shown in FIG. 5, in the region M1 where the first internal electrode layer 12a and the second internal electrode layer 12b adjacent to one another do not overlap each other in the lamination direction, the dielectric layer 11 overlapping the first internal electrode layer 12a in the lamination direction has a region M2 where a large amount of metal elements 21 are diffused from the first internal electrode layer 12a and the second internal electrode layer 12b and a region M3 where a small amount of metal elements 21 are diffused therefrom. In the region M1 where the first internal electrode layer 12a and the second internal electrode layer 12b do not overlap each other in the lamination direction, the first internal electrode layer 12a diffuses the metal elements 21 from the entire surface facing the second internal electrode layer 12b into the dielectric layer 11 in the first direction in the region M2. Thus, the region M2 is a region having a large amount of metal elements 21.

Meanwhile, in the region M1 where the first internal electrode layer 12a and the second internal electrode layer 12b do not overlap each other in the lamination direction, the metal elements 21 from the first internal electrode layer 12a are less likely to reach the region M3, and the metal elements 21 diffused from the end of the second internal electrode layer 12b are also less likely to reach the region M3. Thus, the region M3 is a region having a small amount of metal elements 21. As described above, in the region M1 where the first internal electrode layer 12a and the second internal electrode layer 12b do not overlap each other in the lamination direction, sparseness and denseness of the metal elements 21 diffused from the internal electrode layers 12 occur. In other words, in the regions M1 and M2, more metal elements are diffused as compared to the region M3. Thus, a difference in composition may occur in the dielectric layer 11, i.e., between the regions M1 and M2 and the region MS, and delamination may occur.

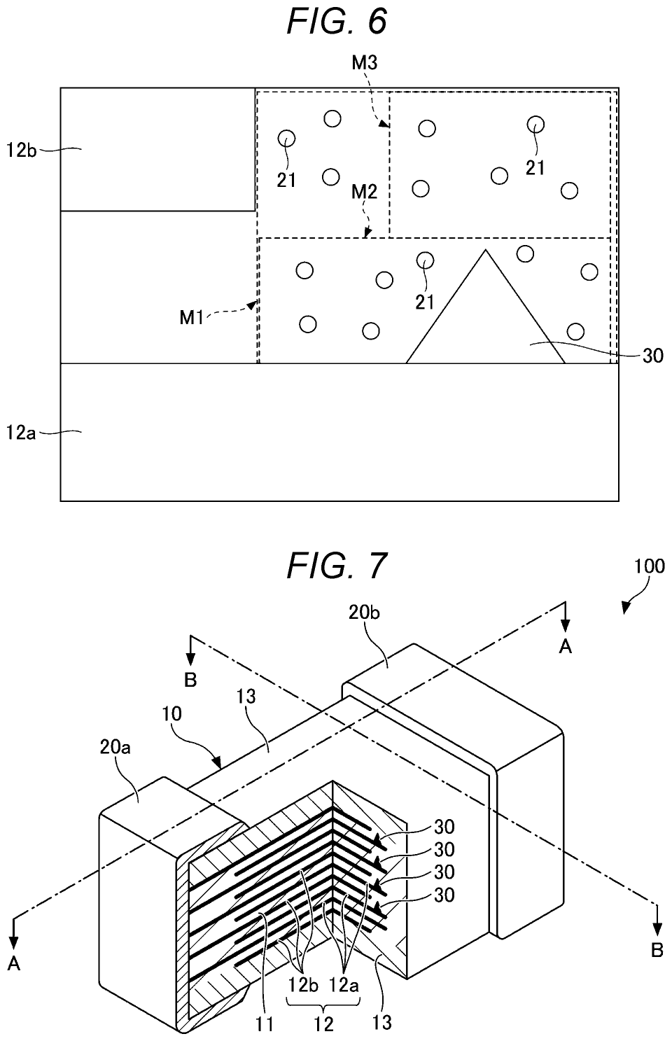

FIG. 6 is an enlarged schematic view of the region M1 in FIG. 3. As shown in FIGS. 3 and 6, in the first internal electrode layer 12a, when the protrusion 30 exists in the region M1 where the first internal electrode layer 12a and the second internal electrode layer 12b do not overlap each other in the lamination direction, the metal elements 21 are also diffused from the protrusion 30, and thus the metal elements 21 are also diffused into the region M3 from the region M1 where the first internal electrode layer 12a and the second internal electrode layer 12b do not overlap each other in the lamination direction. Therefore, sparseness and denseness of the metal elements 21 in the region M1 where the first internal electrode layer 12a and the second internal electrode layer 12b do not overlap each other in the lamination direction are less likely to occur, and a difference in composition is less likely to occur in the region M1 of the dielectric layer 11. In addition, the protrusion 30 itself also serves as a wedge to the dielectric layer 11, and thus its anchor effect improves the adhesion between the dielectric layer and the internal electrode layer, which may further suppress delamination. For example, as illustrated in FIGS. 3 and 6, the protrusion 30 may have a tapered structure in which a first end on the first internal electrode layer 12a tapers, i.e., has a reduced width along the lamination direction, towards the second internal electrode layer 12b. In the particular, as illustrated in FIGS. 3 and 6, the protrusion 30 may form a triangle, e.g., an isosceles triangle, i.e., may have a triangular cross-section (where “triangular” means “triangular” and “substantially triangular”) along the line B-B. Alternatively, the protrusion 30 may have a rounded tip or may have a stepped structure.

The first internal electrode layer 12a has the protrusion 30 on one of the surfaces facing the second internal electrode layer 12b. Because the first internal electrode layer 12a has the protrusion 30 on one of the surfaces facing the second internal electrode layer 12b, a distance between the protrusions does not approach each other. This short circuit between the protrusions 30 may be prevented.

In a case where the first internal electrode layer 12a has two surfaces facing the second internal electrode layer 12b, that is, in a case where both the upper surface and the lower surface of the first internal electrode layer 12a face the second internal electrode layer 12b having the protrusion 30 on the upper surface of the laminated ceramic capacitor 100 makes manufacturing the laminated ceramic capacitor 100 easier.

When the laminated ceramic capacitor 100 is divided into three parts of an upper part, a central part, and a lower part in the lamination direction, the closer to the lower part of the laminated ceramic capacitor 100 in the lamination direction, the more likely the adhesion between the dielectric layer 11 and the internal electrode layer 12 is to be sufficiently secured by pressure bonding at the time of manufacturing the laminated ceramic capacitor 100. Therefore, the laminated ceramic capacitor 100 may have the protrusion 30 at the upper part in the lamination direction, may have the protrusion 30 at the upper part and the central part in the lamination direction, and may have the protrusion 30 at the upper part, the central part, and the lower part in the lamination direction.

The protrusion 30 can be provided in any region where the first internal electrode layer 12a and the second internal electrode layer 12b do not overlap in the lamination direction, and the number of the protrusions 30 may be one or plural. In a case where a plurality of protrusions 30 is provided, the plurality of protrusions 30 exists in the region M1. When the plurality of protrusions 30 is provided, the amount of metal elements 21 diffused into the region M3 increases, and thus a state in which the amount of metal elements 21 is small in the region M3 tends to be eliminated, i.e., the regions M1 to M3 may be more uniform. Thus, further suppression of delamination may be realized.

Further, the protrusion 30 may continuously extend in a second direction that is a direction orthogonal to the lamination direction and the first direction (hereinafter, referred to as the second direction), and such a protrusion 30 extending along the second direction may be included in the protrusion 30. When the protrusion 30 continuously extends in the second direction, the metal elements 21 tend to be diffused in a wide range of the region M3, and thus the state in which the amount of metal elements 21 is small in the region M3 tends to be eliminated, i.e., the regions M1 to M3 may be more uniform. Thus, further suppression of delamination may be realized.

The laminated ceramic capacitor 100 may further include the protrusion 30 continuously extending in the first direction. In that case, the protrusion 30 continuously extending in the first direction is in the first end margin portion 15a and the second end margin portion 15b.

The first internal electrode layers 12a are included in a first laminated structure in which the first internal electrode layers 12a and the dielectric layers 11 are alternately laminated, and the second internal electrode layers 12b are included in a second laminated structure in which the second internal electrode layers 12b and the dielectric layers 11 are alternately laminated. Therefore, in the laminated ceramic capacitor 100, the laminated structure in which the dielectric layers 11 and the internal electrode layers 12 are alternately laminated may have a configuration in which the second laminated structure, the first laminated structure, and the second laminated structure are laminated in order from the bottom in the lamination direction. That is, the second laminated structures may be provided outside the first laminated structure in the lamination direction.

Among the internal electrode layers 12 in the laminated structure of the laminated ceramic capacitor 100, the internal electrode layer 12 at the endmost position in the laminated structure in the lamination direction may be the second internal electrode layer 12b. That is, in the laminated ceramic capacitor 100, the second laminated structure may be at the endmost position in the lamination direction. In this case, when the internal electrode layer 12 located adjacent to the second internal electrode layer 12b at the endmost position in the lamination direction of the laminated ceramic capacitor 100 among the internal electrode layers 12 in the laminated structure is the first internal electrode layer 12a, the region M1 where the first internal electrode layer 12a and the second internal electrode layer 12b do not overlap in the lamination direction can be formed. Thus, the protrusion 30 can be provided in the region M1. Thus, delamination of the laminated ceramic capacitor 100 may be suppressed.

In the laminated ceramic capacitor 100, the first internal electrode layers 12a may be periodically arranged in the lamination direction of a laminated body. The phrase “be periodically arranged” means that layers are arranged at regular intervals in the laminated body. Because the first internal electrode layers 12a are periodically arranged in the lamination direction of the laminated body, a stress difference generated in the laminated body during sintering may be equalized while maintaining high adhesion between the layers of the laminated body. Thus, cracks and uneven sintering of the first side margin portion 16a and the second side margin portion 16b may be suppressed.

An example of the laminated body in which the first internal electrode layers 12a are periodically arranged in the lamination direction is a laminated body in which the first internal electrode layers 12a and the second internal electrode layers 12b are alternately arranged one by one, that is, a laminated body having a laminated structure in which the first laminated structure and the second laminated structure are alternately laminated in the lamination direction.

Another example of the laminated body in which the first internal electrode layers 12a are periodically located in the lamination direction is a laminated body in which a plurality of first internal electrode layers 12a and a plurality of second internal electrode layers 12b are alternately arranged, that is, a laminated body having a laminated structure in which a plurality of first laminated structures and a plurality of second laminated structures are alternately laminated in the lamination direction.

A still another example of the laminated body in which the first internal electrode layers 12a are periodically located in the lamination direction is a laminated body in which a plurality of first internal electrode layers 12a and a plurality of second internal electrode layers 12b are arranged at regular intervals with different numbers of laminated layers, that is, a laminated body having a laminated structure in which a plurality of first laminated structures and a plurality of second laminated structures are laminated at regular intervals in the lamination direction with different numbers of laminated layers.

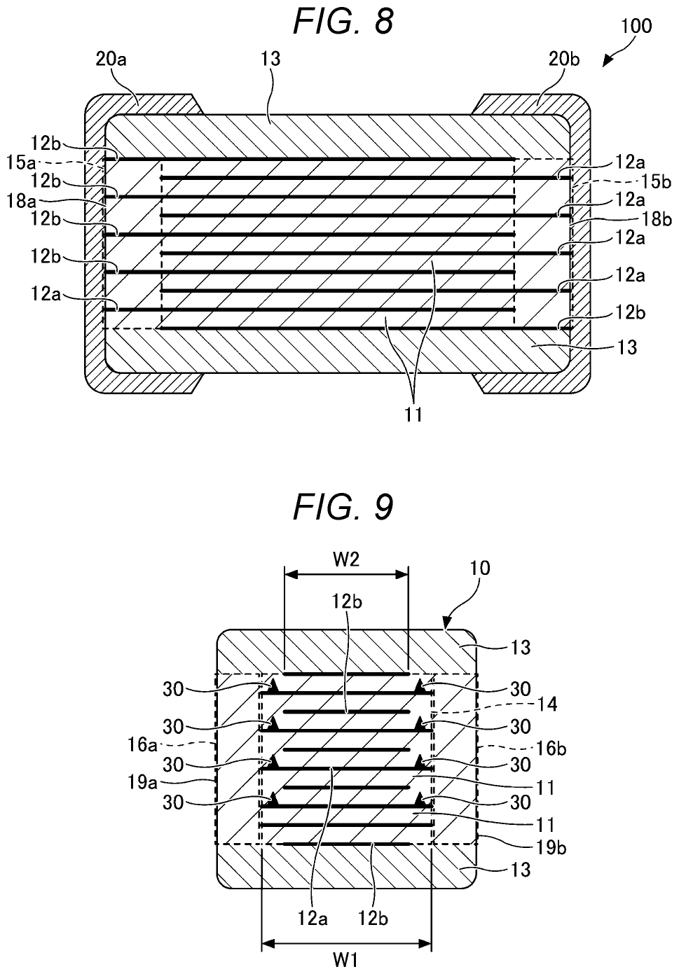

The laminated ceramic capacitor of the present disclosure may have an aspect shown in FIGS. 7 to 9. FIG. 7 is a partial cross-sectional perspective view of an example of a laminated ceramic capacitor according to an aspect of the present disclosure. FIG. 8 is a cross-sectional view taken along line A-A of FIG. 7. FIG. 9 is a cross-sectional view taken along line B-B of FIG. 7.

As shown in FIGS. 7 to 9, in the laminated ceramic capacitor 100, a plurality of protrusions 30 are in a region where the first internal electrode layer and the second internal electrode layer do not overlap each other in the lamination direction in the first internal electrode layer, and the protrusions 30 may continuously extend in the second direction. There are portions in which the first internal electrode layers 12a and the second internal electrode layers 12b are alternately arranged, and thus, in the laminated ceramic capacitor 100 in FIGS. 7 to 9, the first internal electrode layers 12a are periodically arranged in the lamination direction. Further, in the laminated ceramic capacitor 100 in FIGS. 7 to 9, the internal electrode layer at the endmost position in the lamination direction among the internal electrode layers 12 in the laminated structure is the second internal electrode layer 12b.

The protrusion 30 may contain the same metal as the metal contained in the first internal electrode layer 12a. The protrusion 30 may have the same composition as the first internal electrode layer 12a from the viewpoint of the adhesion with the first internal electrode layer 12a.

The length of the protrusion 30 in the lamination direction may be 1.02 times or more, 1.03 times, 1.05 times the thickness of the first internal electrode layer 12a along the lamination direction. When the length of the protrusion 30 in the lamination direction is 1.02 times or more the thickness of the first internal electrode layer 12a, obtain the anchor effect caused by the protrusion 30 serving as a wedge may be realized. The length of the protrusion 30 in the lamination direction may be 3.0 times or less, e.g., 2.5 times or less than the thickness of the first internal electrode layer 12a along the lamination direction. When the length of the protrusion 30 in the lamination direction is 3.0 times or less, a crack caused by a difference in shrinkage between the dielectric layer 11 and the protrusion 30 during sintering is less likely to occur.

The thickness of the internal electrode layer 12 is not particularly limited, but may be, for example, 0.65 m or less, 0.6 m or less from the viewpoint of increasing a capacitance by increasing the number of laminated layers while reducing the size of the laminated ceramic capacitor 100.

A lower limit value of the thickness of the internal electrode layer 12 is not particularly limited, but may be 0.3 m or more, for example.

In evaluating the thickness of the first internal electrode layer 12a, as shown in FIGS. 1 and 7, a sample is prepared by polishing the laminated ceramic capacitor 100 in the first direction, polishing the laminated ceramic capacitor to the center in the first direction to expose cross sections in which the dielectric layers 11 and the internal electrode layers 12 are laminated. Among the exposed cross sections, a cross section corresponding to the first internal electrode layers 12a is selected. At this time, the internal electrode layer 12 to be selected is selected from the inside of the capacitance portion 14.

Then, the thickness of the cross section corresponding to the selected first internal electrode layer 12a is measured at a central position in the second direction, and the thickness is defined as the thickness of the first internal electrode layer 12a.

The length of the protrusion 30 in the lamination direction may be 1.03 m or more and 2.0 m or less. When the length of the protrusion 30 in the lamination direction is 1.03 m or more, the anchor effect caused by the protrusion 30 serving as a wedge may be readily obtained. When the length of the protrusion 30 in the lamination direction is 2.0 m or less, a crack caused by a difference in shrinkage between the dielectric layer 11 and the protrusion 30 during sintering is less likely to occur.

The length of the protrusion 30 in the first direction may be 6% or more and 30% or less of the length of the first internal electrode layer in the first direction.

When the length of the protrusion 30 in the first direction is 6% or more of the length of the first internal electrode layer 12a in the first direction, a decrease in capacitance due to a decrease in continuity rate of the internal electrode layer is less likely to occur, and when the length is 30% or less, the dielectric layer at a portion in which the protrusion 30 exists is less likely to become locally thin, and the shape of the protrusion 30 is less likely to remain in the laminated ceramic capacitor.

Further, a shorter length between the length of the protrusion 30 in the first direction and the length thereof in the second direction may be 6% or more and 30% or less of the length of the first internal electrode layer 12a in the first direction.

The “shorter length between the length of the protrusion in the first direction and the length thereof in the second direction” is the length of the protrusion 30 in the first direction in a case where the protrusion 30 continuously extends in the second direction and is the length of the protrusion 30 in the second direction in a case where the protrusion 30 continuously extends in the first direction. In a case where the protrusion 30 does not continuously extend in either the first direction or the second direction, the length of the protrusion 30 in the first direction may be 6% or more and 30% or less of the length of the first internal electrode layer in the first direction.

When the shorter length between the length of the protrusion 30 in the first direction and the length thereof in the second direction is 6% or more of the length of the first internal electrode layer 12a in the first direction, a decrease in capacitance due to a decrease in continuity rate of the internal electrode layer is less likely to occur, and when the length is 30% or less, the dielectric layer at the portion in which the protrusion 30 exists is less likely to become locally thin, and the shape of the protrusion 30 is less likely to remain in the laminated ceramic capacitor.

The shorter length between the length of the protrusion 30 in the first direction and the length thereof in the second direction may be 0.05 m or more, e.g., 0.1 m or more. When the shorter length between the length of the protrusion 30 in the first direction and the length thereof in the second direction is 0.05 m or more, a decrease in capacitance due to a decrease in the continuity rate of the internal electrode layer is less likely to occur. The shorter length between the length of the protrusion 30 in the first direction and the length thereof in the second direction may be 0.35 m or less, e.g., 0.3 m or less. When the shorter length between the length of the protrusion 30 in the first direction and the length thereof in the second direction is 0.35 m or less, the dielectric layer at the portion in which the protrusion 30 exists is less likely to become locally thin, and the shape of the protrusion 30 is less likely to remain in the laminated ceramic capacitor.

Note that the capacitance of the laminated ceramic capacitor 100 decreases as the width W2 of the second internal electrode layer 12b decreases. Therefore, a ratio of the width W2 that is the length of the second internal electrode layer 12b in the first direction to the width W1 that is the length of the first internal electrode layer 12a in the first direction may be 0.5 or more, e.g., 0.55 or more, e.g., 0.60 or more. Meanwhile, when the ratio of the width W2 of the second internal electrode layer 12b is increased, the region M1 where the first internal electrode layer 12a and the second internal electrode layer 12b do not overlap in the lamination direction is reduced, and after the first internal electrode layer 12a and the second internal electrode layer 12b are laminated, the protrusion 30 arranged in the region M1 and the second internal electrode layer 12b come into contact with each other, which may cause a short circuit when the laminated ceramic capacitor 100 is used. Therefore, the ratio of the width W2 of the second internal electrode layer 12b to the width W1 of the first internal electrode layer 12a may be 0.75 or less, e.g., 0.7 or less, e.g., 0.65 or less.

The widths W1 of the first internal electrode layers 12a may be different from each other within a range of 4%, and the widths W2 of the second internal electrode layers 12b may be different from each other within a range of 44%. Therefore, the ratio of the width W2 of the second internal electrode layer 12b to the width W1 of the first internal electrode layer 12a may be a ratio of an average value of the widths W2 of the plurality of second internal electrode layers 12b to an average value of the widths W1 of the plurality of first internal electrode layers 12a.

The length of the first internal electrode layer 12a in the first direction may be the average value of the widths W1 of the plurality of first internal electrode layers 12a, and the length of the first internal electrode layer 12a in the second direction may be an average value of the lengths of the plurality of first internal electrode layers 12a in the second direction.

The size of the laminated ceramic capacitor 100 is, for example, as follows: 1.6 mm in length, 0.8 mm in width, and 0.8 mm in height; 2.0 mm in length, 1.2 mm in width, and 1.2 mm in height; 3.2 mm in length, 1.6 mm in width, and 1.6 mm in height; 3.2 mm in length, 2.5 mm in width, and 2.5 mm in height; or 4.5 mm in length, 3.2 mm in width, and 2.5 mm in height, but is not limited to those sizes.

The internal electrode layer 12 contains a base metal such as nickel (Ni), copper (Cu), or tin (Sn) as a main component. As the internal electrode layer 12, a noble metal such as platinum (Pt), palladium (Pd), silver (Ag), or gold (Au) or an alloy containing those may be used. The dielectric layer 11 contains a ceramic as a main component and may contain, for example, a ceramic material having a perovskite structure represented by the general formula ABO₃ as a main component. The perovskite structure contains ABO_{3-α} deviating from the stoichiometric composition. For example, the ceramic material can be barium titanate (BaTiO₃), calcium zirconate (CaZrO₃), calcium titanate (CaTiO₃), strontium titanate (SrTiO₃), Ba_{1-x-y}CaₓSr_{y}Ti_{1-Z}Zr_{z}O₃ (0≤x≤1, 0≤y≤1, 0≤z≤1) forming the perovskite structure, or the like.

The protrusion 30 contains the same metal as the metal contained in the internal electrode layer 12. The protrusion 30 may have the same composition as the internal electrode layer 12 from the viewpoint of the adhesion with the internal electrode layer 12.

The thickness of the dielectric layer 11 is, for example, 1 m or less, e.g., 0.8 m or less.

In evaluating the thickness of the dielectric layer 11, as shown in FIGS. 1 and 7, a sample is prepared by polishing the laminated ceramic capacitor 100 in the first direction, polishing the laminated ceramic capacitor to the center in the first direction to expose cross sections in which the dielectric layers 11 and the internal electrode layers 12 are laminated. Among the exposed cross sections, three layers of the dielectric layers 11 are selected from the end of the upper surface, three layers from the end of the lower surface, and three layers located at the center in the lamination direction. At this time, the dielectric layers 11 to be selected are selected from the inside of the capacitance portion 14.

Then, the thickness of the selected dielectric layer 11 is measured at a central position in the second direction and is defined as the thickness of the dielectric layer 11. By measuring the thicknesses of all the selected dielectric layers 11 in the same procedure and evaluating an average value thereof, the thickness of the dielectric layer 11 in the laminated ceramic capacitor 100 can be obtained.

In the laminated ceramic capacitor 100 according to the present embodiment, the number of laminated internal electrode layers 12 per 1 mm of height of the capacitance portion 14 in the lamination direction may be 10 to 600.

### (Method for Manufacturing Laminated Ceramic Capacitor)

A method for manufacturing a laminated ceramic capacitor according to an aspect of the present disclosure includes: a step of forming a first internal electrode layer on a first ceramic green sheet; a step of forming at least one protrusion on the first internal electrode layer; a step of forming a second internal electrode layer having a smaller area than the first internal electrode layer on a second ceramic green sheet; and a step of laminating the second ceramic green sheet on which the second internal electrode layer has been formed on the first ceramic green sheet on which the first internal electrode layer and the protrusion have been formed.

In the step of laminating the second ceramic green sheet on which the second internal electrode layer has been formed on the first ceramic green sheet on which the first internal electrode layer and the protrusion have been formed, the second ceramic green sheet on which the second internal electrode layer has been formed is laminated on the first ceramic green sheet on which the first internal electrode layer and the protrusion have been formed such that the first internal electrode layer is sandwiched between the first ceramic green sheet and the second ceramic green sheet.

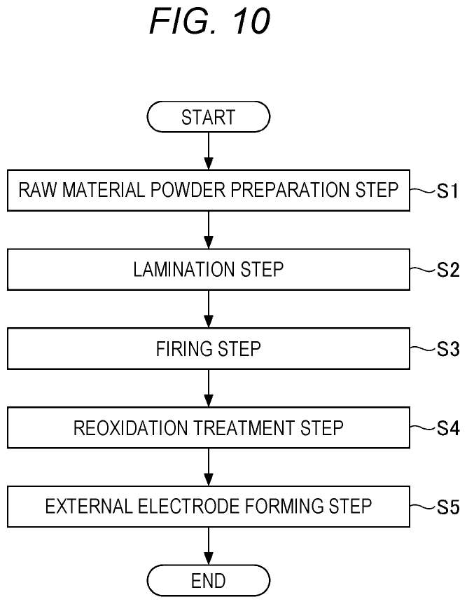

Hereinafter, the method for manufacturing a laminated ceramic capacitor according to an aspect of the present invention will be described. FIG. 10 is a flowchart showing an example of the method for manufacturing a laminated ceramic capacitor according to an aspect of the present disclosure.

### (1) Raw Material Powder Preparation Step (S1)

First, a dielectric material for forming the dielectric layer 11 is prepared. The dielectric material contains a main component ceramic of the dielectric layer 11. An A-site element and a B-site element contained in the dielectric layer 11 are usually contained in the dielectric layer 11 in the form of a sintered body of ABO₃ particles. For example, BaTiO₃ is a tetragonal compound having a perovskite structure and exhibits a high permittivity. This BaTiO₃ can be generally obtained by reacting a titanium raw material such as titanium dioxide with a barium raw material such as barium carbonate to synthesize barium titanate. As a method for synthesizing a main component ceramic of the dielectric layer 11, various methods are conventionally known, and for example, the solid phase method, the sol-gel method, the hydrothermal method, and the like are known. In the present embodiment, any of those can be adopted.

A predetermined additive compound may be added to the obtained ceramic powder depending on the purpose. Examples of the additive compound include oxides of zirconium (Zr), calcium (Ca), strontium (Sr), magnesium (Mg), manganese (Mn), vanadium (V), chromium (Cr), and rare earth elements and oxides or glasses of cobalt (Co), Ni, lithium (Li), boron (B), sodium (Na), potassium (K), and silicon (Si).

Next, a margin material for forming the first end margin portion 15a and the second end margin portion 15b is prepared. The margin material includes a main component ceramic of the first end margin portion 15a and the second end margin portion 15b. For example, BaTiO₃ powder is prepared as the main component ceramic. The BaTiO₃ powder can be prepared by a similar procedure to the dielectric material. A predetermined additive compound is added to the obtained BaTiO₃ powder depending on the purpose. Examples of the additive compound include oxides of Zr, Ca, Sr, Mg, Mn, V, Cr, and rare earth elements and oxides or glasses of Co, Ni, Li, B, Na, K, and Si.

Next, a cover material for forming the cover layer 13 is prepared. The cover material includes a main component ceramic of the cover layer 13. For example, BaTiO₃ powder is prepared as the main component ceramic. The BaTiO₃ powder can be prepared by a similar procedure to the dielectric material. A predetermined additive compound is added to the obtained BaTiO₃ powder depending on the purpose. Examples of the additive compound include oxides of Zr, Ca, Sr, Mg, Mn, V, Cr, and rare earth elements and oxides or glasses of Co, Ni, Li, B, Na, K, and Si. As the cover material, the above margin material may be used.

### (2) Lamination Step (S2)

Next, a binder such as a polyvinyl butyral (PVB) resin, an organic solvent such as ethanol and toluene, and a plasticizer are added to the dielectric material obtained in the raw material powder preparation step and are wet-mixed. Using the obtained slurry, a ceramic green sheet 51 to be a belt-shaped dielectric having a thickness of, for example, 0.8 m or less is applied onto a substrate by, for example, a die coating method or a doctor blade method and is dried.

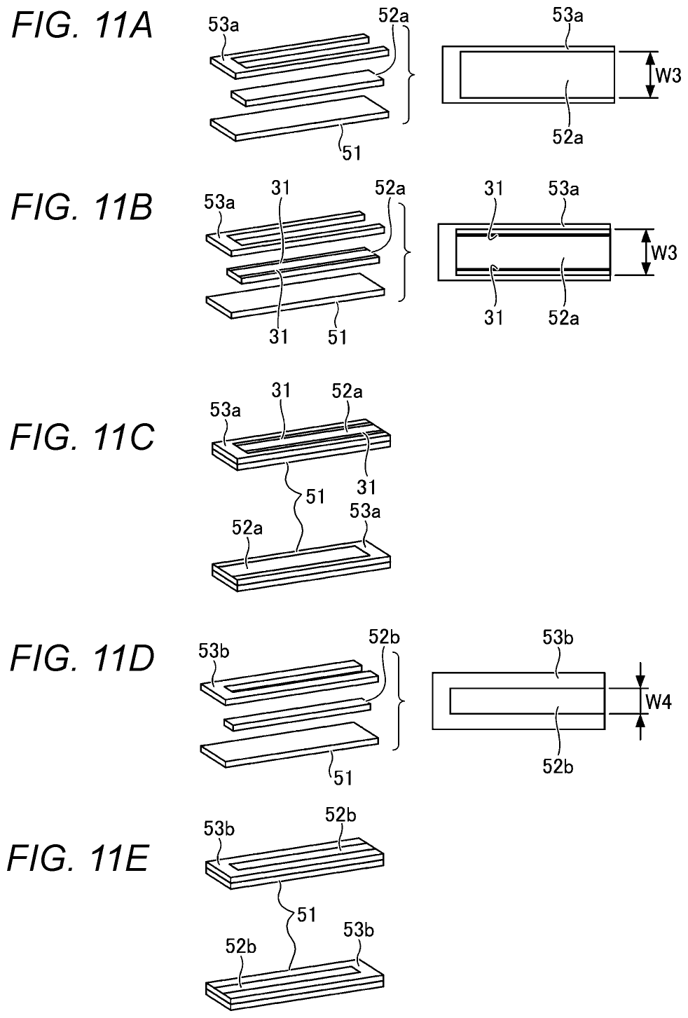

Next, as shown in FIG. 11A, a metal conductive paste for forming the internal electrode layer containing an organic binder is printed on a surface of the ceramic green sheet 51 by screen printing, gravure printing, or the like to arrange a first pattern 52a for the first internal electrode layer. Thus, the first internal electrode layer is formed on the first ceramic green sheet 51. Ceramic particles are added to the metal conductive paste as a common material. The main component of the ceramic particles is not particularly limited, but may be the same as the main component ceramic of the dielectric layer 11.

Next, as shown in FIG. 11B, a metal conductive paste containing an organic binder is printed on a surface of the first pattern 52a by screen printing, gravure printing, or the like to arrange a protrusion pattern 31 on the first pattern 52a. At this time, the protrusion pattern 31 is arranged such that the protrusion 30 is formed on the outside of a first-direction-side edge of a third pattern 52b for the second internal electrode layer described later in the first direction and on the inside of a first-direction-side edge of the first pattern 52a for the first internal electrode layer in the first direction. Thus, the protrusion 30 is formed on the first internal electrode layer 12a.

Next, an ethylcellulose-based or other-based binder and a terpineol-based or other-based organic solvent are added to the margin material obtained in the raw material powder preparation step and are kneaded with a roll mill, thereby obtaining a margin paste for a reverse pattern layer. As shown in FIGS. 11A and 111B, a second pattern 53a may be arranged on the ceramic green sheet 51 by printing a margin paste in a peripheral region where the first pattern 52a is not printed to fill a step with the first pattern 52a.

Thereafter, as shown in FIG. 11C, the ceramic green sheets 51, the first pattern 52a, and the second pattern 53a are laminated such that the first internal electrode layers 12a and the dielectric layers 11 alternate with each other and such that the edges of the first internal electrode layers 12a are alternately exposed to both end surfaces of the dielectric layers 11 in the length direction and are alternately led out to the pair of external electrodes 20a and 20b having different polarities, thereby obtaining a first laminated portion. For example, the number of laminated ceramic green sheets 51 is 20 to 250. In the first laminated portion, the ceramic green sheet 51, the first pattern 52a, and the second pattern 53a in which the protrusion pattern 31 is not formed are not laminated on the ceramic green sheet 51, the first pattern 52a, and the second pattern 53a in which the protrusion pattern 31 is formed.

Next, a second laminated portion is obtained in a similar manner to the step of obtaining the first laminated portion except for arranging the protrusion pattern 31. For example, the number of laminated ceramic green sheets 51 is 20 to 250.

Next, as shown in FIG. 11D, a metal conductive paste for forming the internal electrode layer is printed on the surface of the ceramic green sheet 51 by screen printing, gravure printing, or the like to arrange the third pattern 52b for the second internal electrode layer. A width W4 of the third pattern 52b for the second internal electrode layer in the facing direction of the two side surfaces is narrower than a width W3 of the first pattern 52a for the first internal electrode layer. Therefore, the second internal electrode layer having a smaller area than the first internal electrode layer is formed on the second ceramic green sheet.

As shown in FIG. 11D, a fourth pattern 53b may be arranged on the ceramic green sheet 51 by printing a margin paste in a peripheral region where the third pattern 52b is not printed to fill a step with the third pattern 52b.

Thereafter, as shown in FIG. 11E, the ceramic green sheets 51, the third pattern 52b, and the fourth pattern 53b are laminated such that the second internal electrode layers 12b and the dielectric layers 11 alternate with each other and such that the edges of the second internal electrode layers 12b are alternately exposed to both end surfaces of the dielectric layers 11 in the length direction and are alternately led out to the pair of external electrodes 20a and 20b having different polarities, thereby obtaining a third laminated portion. For example, the number of laminated ceramic green sheets 51 is 20 to 250.

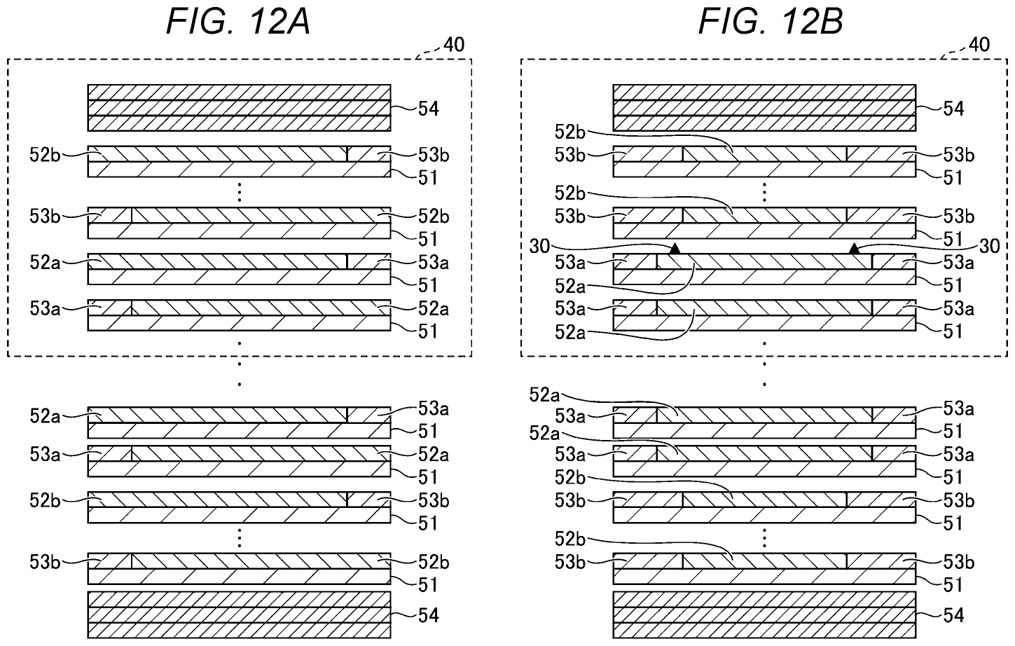

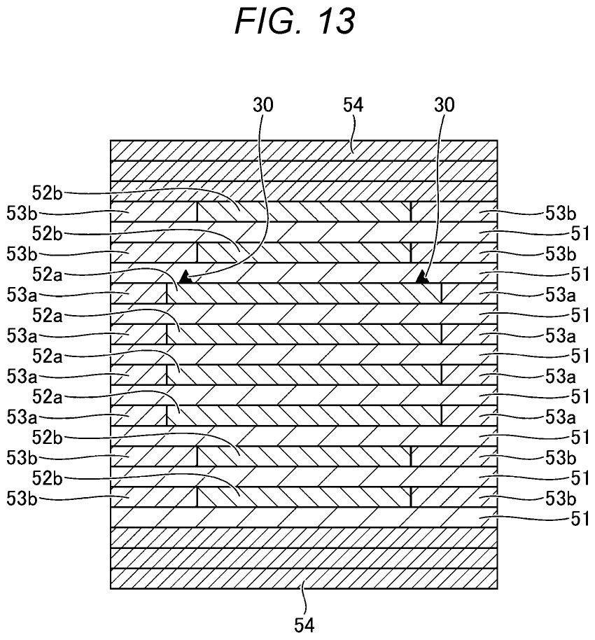

Next, as shown in FIGS. 12A and 12B, the third laminated portion, the second laminated portion, the first laminated portion, and the third laminated portion are sequentially laminated to obtain a ceramic laminated body. Note that the second laminated portion, the first laminated portion, and the third laminated portion are laminated in this order to obtain a laminated body 40 including the protrusions 30 indicated by dotted lines in FIGS. 12A and 12B, and then the ceramic green sheets 51 on lower surfaces of the two laminated bodies 40 are combined to bond the two laminated bodies 40, whereby one ceramic laminated body can also be obtained. FIG. 12A is a cross-sectional view corresponding to the A-A cross section of FIG. 1, and FIG. 12B is a cross-sectional view corresponding to the B-B cross section of FIG. 1.

Next, a binder such as a polyvinyl butyral (PVB) resin, an organic solvent such as ethanol and toluene, and a plasticizer are added to the cover material obtained in the raw material powder preparation step and are wet-mixed. Using the obtained slurry, a belt-shaped cover sheet 54 having a thickness of, for example, 10 m or less is applied onto a substrate by, for example, a die coating method or a doctor blade method and is dried. As shown in FIGS. 12A and 12B, a predetermined number (for example, 2 to 10 layers) of cover sheets 54 are laminated on and under the ceramic laminated body, are thermocompression-bonded, and are cut into a predetermined chip size (for example, 1.6 mm×0.8 mm). Note that a predetermined number of cover sheets 54 may be laminated and bonded, and then attached to the upper and lower sides of the ceramic laminated body.

### 9 (3) Firing Step (S3)

The ceramic laminated body thus obtained is fired, for example, at a firing temperature of about 1100° C. to 1400° C. for about 2 hours in a reducing atmosphere with H₂ of about 1.0 vol %. In this manner, the laminated chip 10 in which the dielectric layers 11 and the internal electrode layers 12 made from the sintered body are alternately laminated and the cover layers 13 are formed as the outermost layers is obtained. In order to suppress deterioration of temperature characteristics due to oversintering, the firing temperature may be set to 1100° C. to 1200° C.

### (4) Reoxidation Treatment Step (S4)

Thereafter, reoxidation treatment may be performed at 600° C. to 1000° C. in a N₂ gas atmosphere.

### (5) External Electrode Forming Step (S5)

Next, a conductive paste for forming the external electrode is applied to two end surfaces of the fired laminated chip 10 whose internal electrode layer patterns are exposed. The conductive paste for forming the external electrode contains powder of a main component metal (Cu in the present embodiment) of the external electrodes 20a and 20b, a glass component, a binder, a solvent, and other auxiliary agents as necessary. For the binder and the solvent, those similar to the above ceramic paste can be used.

Next, the laminated chip 10 applied with the conductive paste for forming the external electrode is baked at a temperature of about 770° C. or less in a nitrogen atmosphere. Thus, the external electrodes 20a and 20b are baked.

Thereafter, the external electrodes 20a and 20b may be coated with a metal such as Cu, Ni, or Sn by plating.

The above steps are merely an example, and the method for manufacturing a laminated ceramic capacitor of the present aspect is not limited to the above embodiment.

For example, in a case where no pattern is arranged in a portion to be a side margin portion in the laminated ceramic capacitor in the lamination step (S2), the side margin portion may be formed by laminating the dielectric layers 11 and the internal electrode layers 12, then cutting out a laminated body having only the capacitance portion 14a, the capacitance portion 14b, and the margin portion 17 so as to expose the cross sections of the dielectric layers 11 and the internal electrode layers 12, and attaching a sheet made from a side margin paste or applying the side margin paste to the side surface of the laminated body where the cross section of the dielectric layers 11 and the cross section of the internal electrode layers 12 are exposed.

Part of the processing in step S5 described above may be performed before step S3. For example, an unfired conductive paste for forming the external electrode may be applied to two end surfaces of the unfired ceramic laminated body before step S3, and the unfired conductive paste for forming the external electrode may be baked at the same time as the unfired ceramic laminated body is fired in step S3, thereby forming base layers of the external electrodes 20a and 20b. Alternatively, the unfired conductive paste for forming the external electrode may be applied to the two end surfaces of the ceramic laminated body subjected to binder removal treatment, and those may be fired simultaneously.

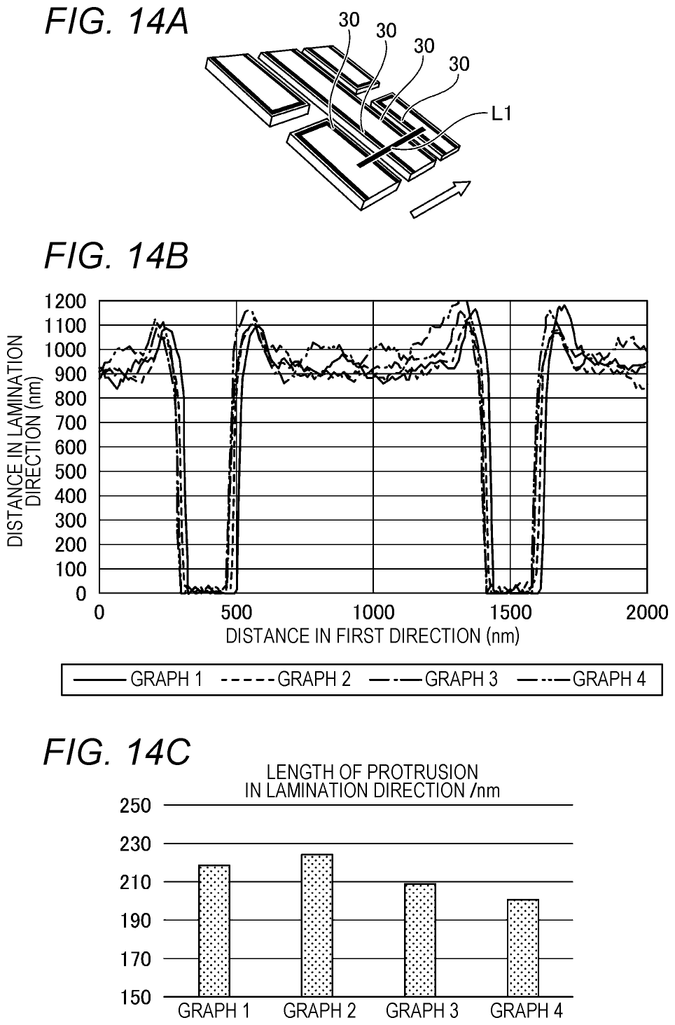

FIG. 14A shows a result of surface shape analysis of the first internal electrode layers 12a having the protrusions 30 formed thereon in the first direction by a three-dimensional optical surface shape/roughness measuring instrument (Zygo Newview™ 9000). In FIG. 14A, dark color portions are the protrusions 30. It can be confirmed from FIG. 14A that the protrusions 30 are formed and can also be confirmed that the protrusions 30 continuously extend in the second direction. It can also be confirmed that there is a plurality of protrusions 30.

The graph of FIG. 14B shows a change in length in the lamination direction when the surface shape of the first internal electrode layers 12a in FIG. 14A is subjected to line analysis on a line L1 a plurality of times in the first direction shown by the arrow. It can be confirmed from FIG. 14B that the protrusions 30 are formed because there are remarkable peaks in the graph of each line analysis. In each graph of FIG. 14B, the length of each protrusion 30 in the lamination direction in each graph was obtained by obtaining a value obtained by subtracting an average height on the surface of the first internal electrode layer 12a where the protrusion 30 is not formed from each peak value (average height=an average value of lengths in the lamination direction of portions where no protrusion is formed among portions where the lengths in the lamination direction have been measured on the line Li). The results are shown in FIG. 14C.

By averaging the lengths of the protrusions 30 in the lamination direction shown by the respective graphs, the length of the protrusion 30 in the lamination direction formed by the protrusion pattern 31 can be obtained.

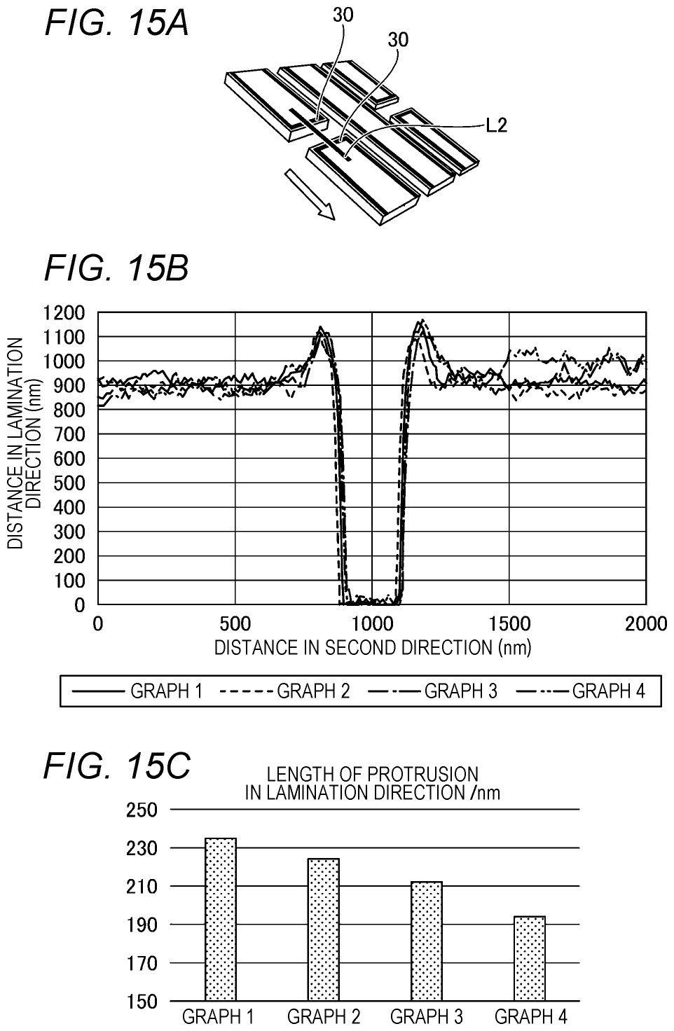

As in a similar manner to the above, FIG. 15A shows a result of surface shape analysis of the first internal electrode layers 12a having the protrusions 30 formed thereon in the second direction by the three-dimensional optical surface shape/roughness measuring instrument (Zygo Newview™ 9000). In FIG. 15A, as well as in FIG. 14A, dark color portions are the protrusions 30. It can be confirmed from FIG. 15A that the protrusions 30 are formed and can also be confirmed that the protrusions 30 continuously extend in the first direction.

The graph of FIG. 15B shows a change in length in the lamination direction when the surface shape of the first internal electrode layers 12a in FIG. 15A is subjected to line analysis on a line L2 a plurality of times in the second direction. It can be confirmed from FIG. 15B that the protrusions 30 are formed because there is a remarkable peak in the graph of each line analysis. In each graph of FIG. 15B, the length of each protrusion 30 in the lamination direction in each graph was obtained by obtaining a value obtained by subtracting an average height on the surface of the first internal electrode layer 12a where the protrusion 30 is not formed from each peak value (average height=an average value of lengths in the lamination direction of portions where no protrusion is formed among portions where the lengths in the lamination direction have been measured on the line L2). The results are shown in FIG. 15C. By averaging the lengths of the protrusions 30 in the lamination direction shown by the respective graphs, the length of the protrusion 30 in the lamination direction formed by the protrusion pattern 31 can be obtained.

It was shown from the results of FIGS. 14A to 14C and FIGS. 15A to 15C that a protrusion can be formed on the internal electrode layer.

Aspects of the present disclosure are, for example, as follows.

<1> A laminated ceramic capacitor including
a laminated body having a laminated structure in which a plurality of dielectric layers containing a ceramic as a main component and a plurality of internal electrode layers are alternately laminated, in which:
the laminated body has a first side surface and a second side surface facing each other and a first end surface and a second end surface facing each other;
the internal electrode layers include a first internal electrode layer and a second internal electrode layer;
a length of the first internal electrode layer in a first direction in which the first side surface and the second side surface face each other is longer than a length of the second internal electrode layer in the first direction;
the first internal electrode layer has at least one protrusion on one surface facing the second internal electrode layer; and
the protrusion is in a region where the first internal electrode layer and the second internal electrode layer do not overlap in a lamination direction in the first internal electrode layer.

<2> The laminated ceramic capacitor according to the above <1>, in which the protrusion continuously extends in a second direction that is a direction orthogonal to the lamination direction and the first direction.

<3> The laminated ceramic capacitor according to the above <1> or <2>, further including a protrusion continuously extending in the first direction.

<4> The laminated ceramic capacitor according to any one of the above <1>, <2>, and

<3>, in which the internal electrode layer at an endmost position in the lamination direction among the internal electrode layers in the laminated structure is the second internal electrode layer.

<5> The laminated ceramic capacitor according to any one of the above <1>, <2>, <3>, and <4>, in which a length of the protrusion in the lamination direction is 1.02 times or more and 3.0 times or less an average thickness of the first internal electrode layers.

<6> The laminated ceramic capacitor according to any one of the above <1>, <2>, <3>, <4>, and <5>, in which a length of the protrusion in the first direction is 6% or more and 30% or less of the length of the first internal electrode layer in the first direction.

<7> The laminated ceramic capacitor according to any one of the above <1>, <2>, <3>, <4>, <5>, and <6>, in which a shorter length between the length of the protrusion in the first direction and a length of the protrusion in the second direction is 6% or more and 30% or less of the length of the first internal electrode layer in the first direction.

<8> The laminated ceramic capacitor according to any one of the above <1>, <2>, <3>, <4>, <5>, <6>, and <7>, in which the first internal electrode layers are periodically arranged in the lamination direction in the laminated body.

<9> The laminated ceramic capacitor according to any one of the above <1>, <2>, <3>, <4>, <5>, <6>, <7>, and <8>, wherein the protrusion is in a region where the first internal electrode layer and the second internal electrode layer do not overlap in the lamination direction in the first internal electrode layer, wherein the protrusion extends from the first surface of the first internal electrode layer along the lamination direction towards the second internal electrode layer.

<10> The laminated ceramic capacitor according to any one of the above <1>, <2>, <3>, <4>, <5>, <6>, <7>, <8> and <9>, wherein the at least one protrusion is tapered from the first internal electrode layer to the second internal electrode layer along the lamination direction.

<11> The laminated ceramic capacitor according to <10>, wherein the at least one protrusion has a triangular cross-section.

<12> The laminated ceramic capacitor according to any one of the above <1>, <2>, <3>, <4>, <5>, <6>, <7>, <8>, <9>, <10> and <11>, wherein the at least one protrusion and the at least one first internal electrode layer are made of a same material.

<13> The laminated ceramic capacitor according to any one of the above <1>, <2>, <3>, <4>, <5>, <6>, <7>, <8>, <9>, <10>, and <11>, wherein a ratio of a width of the second internal electrode layer to a width of the first internal electrode layer is 0.5 or more and 0.75 or less.

<14> The laminated ceramic capacitor according to any one of the above <1>, <2>, <3>, <4>, <5>, <6>, <7>, <8>, <9>, <10>, <11>, <12> and <13>, wherein the at least one protrusion extends upwards along the lamination direction.

<15> A method for manufacturing a laminated ceramic capacitor, the method including: forming a first internal electrode layer on a first ceramic green sheet;
forming at least one protrusion on the first internal electrode layer;
forming a second internal electrode layer having a smaller area than the first internal electrode layer on a second ceramic green sheet; and
laminating the second ceramic green sheet on which the second internal electrode layer has been formed on the first ceramic green sheet on which the first internal electrode layer and the protrusion have been formed.

<16> The method according to <15>, wherein the at least one protrusion is in a region where the first internal electrode layer and the second internal electrode layer do not overlap in a lamination direction in the first internal electrode layer, wherein the protrusion extends from the first surface of the first internal electrode layer along the lamination direction towards the second internal electrode layer.

<17> The method according to <16>, wherein the at least one protrusion extends upwards along the lamination direction.

<18> The method according to any one of <15>, <16> and <17>, wherein the at least one protrusion and the first internal electrode layer are made of a same material.

<19> The method according to any one of <15>, <16>, <17> and <18>, further including forming another first internal electrode layer on a third ceramic green sheet, wherein the another first internal electrode layer has no protrusion; and laminating further includes laminating the first internal electrode layer on the another first internal electrode layer.

<20> The method according to any one of <15>, <16>, <17> and <18>, further including forming another second internal electrode layer on a third ceramic green sheet and laminating further includes laminating the first internal electrode layer on the another second internal electrode layer.

The laminated ceramic capacitor according to any one of the above <1> to <14> and the method for manufacturing a laminated ceramic capacitor according to the above <15> to <20> can solve various conventional problems and may provide a laminated ceramic capacitor having excellent adhesion between a dielectric layer and an internal electrode layer and capable of suppressing delamination.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. The presently disclosed embodiments are therefore considered to be illustrative and not restrictive. For example, while the protrusions disclosed herein are illustrated as extending upwards along the lamination direction, the protrusions could extend downward along the lamination direction, as long as the protrusions are in a region M1 in which first and second internal electrode layers do not overlap. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure.

The scope of the invention is indicated by the appended claims, rather than the foregoing description.

What is claimed is:

1. A laminated ceramic capacitor comprising:
a laminated body having a laminated structure in which a plurality of dielectric layers containing a ceramic as a main component and a plurality of internal electrode layers are alternately laminated, wherein,
the laminated body has a first side surface and a second side surface facing each other and a first end surface and a second end surface facing each other,
the internal electrode layers include a first internal electrode layer and a second internal electrode layer,
a length of the first internal electrode layer in a first direction in which the first side surface and the second side surface face each other is longer than a length of the second internal electrode layer in the first direction,
the first internal electrode layer has at least one protrusion on a first surface facing the second internal electrode layer, and
the protrusion is in a region where the first internal electrode layer and the second internal electrode layer do not overlap in a lamination direction in the first internal electrode layer.

2. The laminated ceramic capacitor according to claim 1, wherein the protrusion continuously extends in a second direction that is a direction orthogonal to the lamination direction and the first direction.

3. The laminated ceramic capacitor according to claim 2, further the protrusion continuously extends in the first direction.

4. The laminated ceramic capacitor according to claim 1, wherein the internal electrode layer at an endmost position in the lamination direction among the internal electrode layers in the laminated structure is the second internal electrode layer.

5. The laminated ceramic capacitor according to claim 1, wherein a length of the protrusion in the lamination direction is 1.02 times or more and 3.0 times or less a thickness of the first internal electrode layers.

6. The laminated ceramic capacitor according to claim 1, wherein a length of the protrusion in the first direction is 6% or more and 30% or less of the length of the first internal electrode layer in the first direction.

7. The laminated ceramic capacitor according to claim 2, wherein a shorter length of the length of the protrusion in the first direction and a length of the protrusion in the second direction is 6% or more and 30% or less of the length of the first internal electrode layer in the first direction.

8. The laminated ceramic capacitor according to claim 1, wherein the first internal electrode layers are periodically arranged in the lamination direction in the laminated body.

9. The laminated ceramic capacitor according to claim 1, wherein the protrusion is in a region where the first internal electrode layer and the second internal electrode layer do not overlap in the lamination direction in the first internal electrode layer, wherein the protrusion extends from the first surface of the first internal electrode layer along the lamination direction towards the second internal electrode layer.

10. The laminated ceramic capacitor according to claim 9, wherein the at least one protrusion is tapered from the first internal electrode layer to the second internal electrode layer along the lamination direction.

11. The laminated ceramic capacitor according to claim 10, wherein the at least one protrusion has a triangular cross-section in a cross-section of the laminated ceramic capacitor along the first direction.

12. The laminated ceramic capacitor according to claim 1, wherein the at least one protrusion and the first internal electrode layer are made of a same material.

13. The laminated ceramic capacitor according to claim 1, wherein a ratio of a width of the second internal electrode layer to a width of the first internal electrode layer is 0.5 or more and 0.75 or less.

14. The laminated ceramic capacitor according to claim 1, wherein the at least one protrusion extends upwards along the lamination direction.

15. A method for manufacturing a laminated ceramic capacitor comprising:
forming a first internal electrode layer on a first ceramic green sheet;
forming at least one protrusion on the first internal electrode layer;
forming a second internal electrode layer having a smaller area than the first internal electrode layer on a second ceramic green sheet; and
laminating the second ceramic green sheet on which the second internal electrode layer has been formed on the first ceramic green sheet on which the first internal electrode layer and the protrusion have been formed.

16. The method according to claim 15, wherein the at least one protrusion is in a region where the first internal electrode layer and the second internal electrode layer do not overlap in a lamination direction in the first internal electrode layer, wherein the protrusion extends from the first surface of the first internal electrode layer along the lamination direction towards the second internal electrode layer.

17. The method according to claim 16, wherein the at least one protrusion extends upwards along the lamination direction.

18. The method according to claim 15, wherein the at least one protrusion and the first internal electrode layer are made of a same material.

19. The method according to claim 15, further comprising:
forming another first internal electrode layer on a third ceramic green sheet, wherein the another first internal electrode layer has no protrusion; and
laminating further includes laminating the first internal electrode layer on the another first internal electrode layer.

20. The method according to claim 15, further comprising:
forming another second internal electrode layer on a third ceramic green sheet; and
laminating further includes laminating the first internal electrode layer on the another second internal electrode layer.
